(19) United States
(12) Patent Application Publication
(10) Pub. No.: US 2025/0184929 A1
(43) Pub. Date: Jun. 5, 2025

(54) REFERENCE SIGNAL TIME DIFFERENCE (RSTD) IN A NON-TERRESTRIAL WIRELESS NETWORK (NTN)

(71) Applicant: Apple Inc., Cupertino, CA (US)

(72) Inventors: Chunxuan YE, San Diego, CA (US); Dawei Zhang, Saratoga, CA (US); Wei Zeng, Saratoga, CA (US); Chunhai Yao, Beijing (CN); Yuqin Chen, Beijing (CN); Fangli Xu, Beijing (CN); Hong He, San Jose, CA (US); Haijing Hu, Los Gatos, CA (US)

(73) Assignee: Apple Inc., Cupertino, CA (US)

(21) Appl. No.: 18/939,888

(22) Filed: Nov. 7, 2024

Related U.S. Application Data
(60) Provisional application No. 63/604,584, filed on Nov. 30, 2023.

(51) Int. Cl. H04W 56/00

(52) U.S. Cl. CPC H04W 56/001; H04W 56/0065

(57) ABSTRACT

Mechanisms are provided for a user equipment (UE) to determine a user equipment (UE) location in a non-terrestrial wireless network (NTN) based on a reference signal time difference (RSTD). A RSTD is determined based on a sending time difference and a receiving time difference, where the sending time difference is a time difference between a first sending time instance when a first subframe of a first position reference signal (PRS) is sent, and a second sending time instance when a second subframe of a second PRS is sent. In addition, the receiving time difference is a time difference between a first receiving time instance when the first subframe of the first PRS is received, and a second receiving time instance when the second subframe of the second PRS is received.

### RELATED APPLICATIONS

This application claims benefit of U.S. Provisional Patent Application No. 63/604,584 filed Nov. 30, 2023, the content of which is herein incorporated by references in its entirety.

### BACKGROUND

### Field

The described aspects generally relate to a non-terrestrial wireless network (NTN), including determination of a user equipment (UE) location in the NTN based on a reference signal time difference (RSTD).

### Related Art

A wireless communication system can include a fifth generation (5G) system, a New Radio (NR) system, a long term evolution (LTE) system, a non-terrestrial wireless network (NTN), a combination thereof, or some other wireless systems. In addition, a wireless communication system can support a wide range of use cases such as enhanced mobile broad band (eMBB), massive machine type communications (mMTC), ultra-reliable and low-latency communications (URLLC), enhanced vehicle to anything communications (eV2X), among others. Enabling support for non-terrestrial networks has been one direction under exploration in the Third Generation Partnership Project (3GPP).

### SUMMARY

Some aspects of this disclosure relate to apparatuses and methods for implementing techniques for determination of a user equipment (UE) location in a non-terrestrial wireless network (NTN) based on a reference signal time difference (RSTD) without global navigation satellite systems (GNSS) information in the NTN. A RSTD is determined based on a sending time difference and a receiving time difference, where the sending time difference is a time difference between a first sending time instance when a first subframe of a first position reference signal (PRS) is sent, and a second sending time instance when a second subframe of a second PRS is sent. In addition, the receiving time difference is a time difference between a first receiving time instance when the first subframe of the first PRS is received, and a second receiving time instance when the second subframe of the second PRS is received. The so-defined RSTD takes into consideration of the longer delay in an NTN system in comparison with a terrestrial wireless network where a RSTD may typically be defined simply as the receiving time difference. The implemented techniques can be applicable to many wireless systems, e.g., a wireless communication system based on 3rd Generation Partnership Project (3GPP) release 15 (Rel-15), release 16 (Rel-16), release 17 (Rel-17), or beyond.

Some aspects of this disclosure relate to a UE. The UE can include a transceiver configured to enable wireless communication in an NTN, and a processor communicatively coupled to the transceiver. The processor can receive, at a first receiving time instance, a first subframe of a first PRS sent at a first sending time instance by a first base station, where a time difference between the first receiving time instance and the first sending time instance is larger than a duration of a subframe. In addition, the processor can receive, at a second receiving time instance, a second subframe of a second PRS sent at a second sending time instance by a second base station, where the second PRS is generated at a time different from a time the first PRS being generated. In some embodiments, the first PRS is generated with a first PRS sequence identifier, and the second PRS is generated with a second PRS sequence identifier different from the first PRS sequence identifier.

Afterwards, the processor can determine a sending time difference between the first sending time instance for the first subframe and the second sending time instance for the second subframe. In addition, the processor can determine a RSTD based on a receiving time difference and the sending time difference, where the receiving time difference is a time difference between the first receiving time instance and the second receiving time instance. Furthermore, the UE may receive a time difference value range including an upper bound and a lower bound for the RSTD.

In some embodiments, the sending time difference between the first sending time instance and the second sending time instance can be determined based on a time offset between the first subframe and the second subframe, or based on a subframe index offset between the first subframe and the second subframe. In some embodiments, the processor can receive system information from the first base station or the second base station to indicate the sending time difference between the first sending time instance for the first subframe and the second sending time instance for the second subframe.

According to some aspects, the processor can further receive, at a third receiving time instance, a third subframe of a third PRS sent at a third sending time instance by the second base station, where the third PRS and the first PRS are generated at a same time coordinated by a location management function (LMF) of the NTN, and the second receiving time instance is closer to the first receiving time instance than the third receiving time instance. The RSTD equals to a time difference between the first receiving time instance and the third receiving time instance.

According to some aspects, the processor can further determine a downlink time difference of arrival (TDOA) for the UE based on the determined RSTD, where the TDOA is used to determine a location of the UE. In addition, the processor can apply, based on the determined location of the UE, an open loop time advance control for uplink transmissions from the UE to the first base station and the second base station.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIGS. 1A-1C illustrate a non-terrestrial wireless network (NTN) including a user equipment (UE) to determine a reference signal time difference (RSTD), according to some aspects of the disclosure.

FIG. 2 illustrates a block diagram of a UE including a transceiver and a processor to determine a RSTD in an NTN, according to some aspects of the disclosure.

FIGS. 3A-3C illustrate an example process performed by a UE for determining a RSTD in an NTN, according to some aspects of the disclosure.

FIG. 4 illustrates an example process performed by a UE for determining a RSTD in an NTN, according to some aspects of the disclosure.

FIG. 5 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Non-terrestrial wireless networks (NTN) or non-terrestrial networks can refer to any network that involves non-terrestrial flying objects. An NTN can include a satellite communication network, a high altitude platform systems (HAPS), an air-to-ground network, a low-altitude unmanned aerial vehicles (UAVs, aka. drones), or any other NTN network.

In an NTN system, a location of a user equipment (UE) can play an important role in various functions such as delay and Doppler compensation for time and frequency synchronization of the UE. In some systems, the location of a UE can be determined based on Global Navigation Satellite System (GNSS) information. However, in some NTN systems, a UE may not have access to GNSS information for various reasons, e.g., due to the capability of the UE or the reception condition such as channel conditions of the UE. Other mechanisms for the UE to determine the location of the UE may be desired.

In some wireless systems, the location of a UE may be determined based on multiple position reference signals (PRSs) transmitted from two or more base stations, such as gNBs, transmission points, or satellites. The UE may perform PRS measurements and determine a reference signal time difference (RSTD) based on the PRSs from the multiple base stations. Furthermore, the UE can calculate downlink time difference of arrival (DL-TDOA) that is used to determine the location of the UE. In addition, the UE can apply open loop time advance control for uplink transmissions from the UE to base stations, based on its determined location of the UE.

However, determining the location of the UE based on multiple PRSs may require very good synchronization among multiple base stations, which may post serious challenges for an NTN system. For example, in an NTN system, the absolute propagation delay can be much larger than 1 ms, which can be larger than a duration of a subframe. The relative propagation delay from two satellite to a common UE can also be much larger than 1 ms. Hence, ways used by a UE to determine a RSTD based on the PRSs in a normal terrestrial wireless network may not work for an NTN system.

Embodiments herein can provide a mechanism for determining a RSTD based on multiple PRSs for an NTN system. In some embodiments, the RSTD can be an absolute time difference between two PRSs from two different base stations received by the UE. In some other embodiments, the RSTD can be determined based on an additional time offset between two PRSs from two different base stations received by the UE. The absolute time difference or the time offset may be calculated based on the timings of a first subframe from a first transmission point and a second subframe from a second transmission point, where the first subframe has a linkage with the second subframe. In addition, a network entity, such as a location management function (LMF), can align the spatial direction information of the PRS resources and polarization information between two base stations.

Accordingly, a same polarization can be applied for PRS transmissions from two base stations on the beams covering the same area where the UE is located.

In some embodiments, a RSTD is determined based on a sending time difference and a receiving time difference, where the sending time difference is a time difference between a first sending time instance when a first subframe of a first PRS is sent, and a second sending time instance when a second subframe of a second PRS is sent. In addition, the receiving time difference is a time difference between a first receiving time instance when the first subframe of the first PRS is received, and a second receiving time instance when the second subframe of the second PRS is received. A RSTD for other wireless system may only take consideration of the receiving time difference.

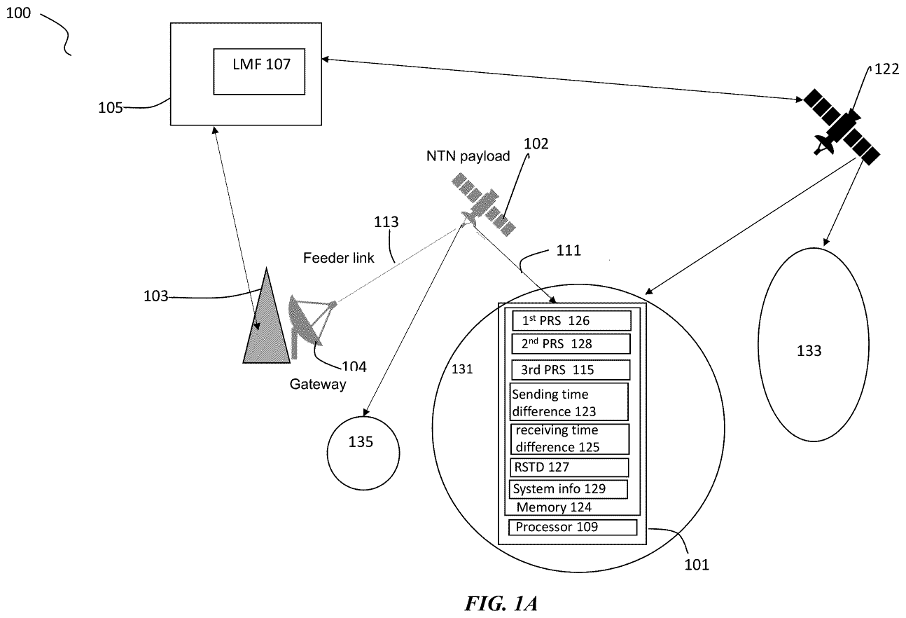

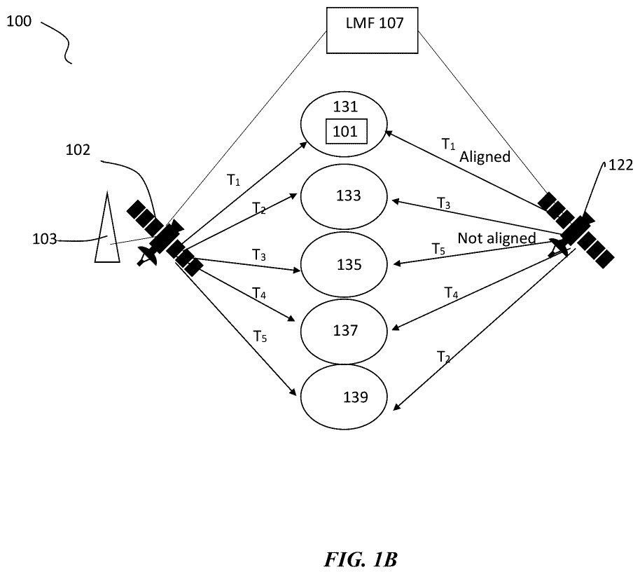

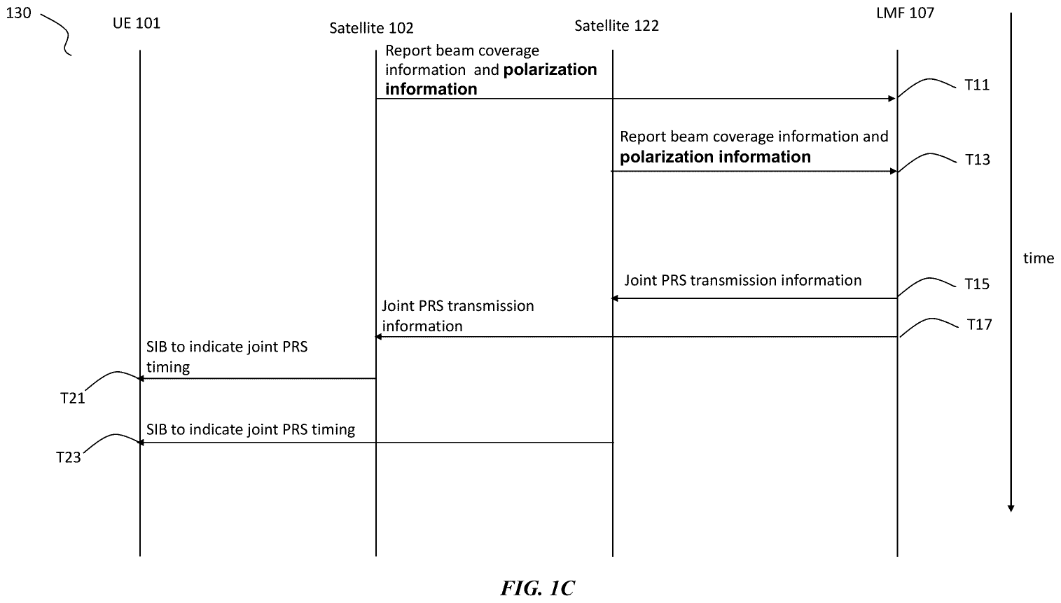

FIG. 1A-1C illustrate a wireless system, e.g., NTN 100 including a UE 101 to determine a RSTD, according to some aspects of the disclosure. NTN 100 is provided for the purpose of illustration only and does not limit the disclosed aspects.

As shown in FIG. 1A, NTN 100 can include, but is not limited to, UE 101, a base station 103, a satellite 102, a gateway 104, a satellite 122, and a core network 105 that includes a location management function (LMF) 107. In some embodiments, LMF 107 is coupled to satellite 102 through gateway 104. In some embodiments, LMF 107 is coupled to satellite 122 directly, where a gateway may be located on satellite 122. UE 101 communicates with satellite 102 through a service link 111, and satellite 102 communicates with gateway 104 through a feeder link 113. Satellite 102 can include a network node and transceiver for wireless communication. There can be various implementations of NTN 100. For example, base station 103 and gateway 104 may be integrated into one unit instead of being separated components. Base station 103 and core network 105 may implement functions as a normal terrestrial wireless network without a satellite, while gateway 104 may implementation functions between a terrestrial wireless network and satellite 102. In addition, NTN 100 can include satellite 122, which may include a base station and a gateway, not shown. Satellite 122 can be coupled to core network 105 and LMF 107 as well. UE 101 may be located in a cell 131. Satellite 122 may communicate with UEs in cell 131 and cell 133, and satellite 102 may communicate with UEs in cell 131 and cell 135 at various time periods, which will be shown in FIG. 1B.

In some embodiments, NTN 100 can have a transparent payload, where base station 103 is located on the ground. In some embodiments, NTN 100 can have a regenerative payload when base station 103 can be located on satellite 102. There can be multiple satellites with onboard base stations communicating with each other. There can be other network entities, e.g., network controller, a relay station, not shown. An NTN can be referred to as a wireless network, a wireless communication system, or some other names known to a person having ordinary skill in the art.

In some embodiments, NTN 100 can be an NTN having a non-terrestrial flying object, e.g., satellite 102 or satellite 122. In some embodiments, NTN 100 can include a satellite communication network that includes satellite 102, satellite 122, a HAPS, or an air-to-ground network, or a UAV. There can be multiple satellites in NTN 100. Satellite 102 or satellite 122 can be a low Earth orbiting (LEO) satellite, a medium Earth orbiting (MEO) satellite, or a geosynchronous Earth orbiting (GEO) satellite. NTN 100 can be a HAPS, which can be an airborne platform including airplanes, balloons, and airships. For example, NTN 100 can include the International Mobile Telecommunications base stations, known as HIBS. A HIBS system can provides mobile service in the same transmission frequencies used by terrestrial mobile networks. NTN 100 can be an air-to-ground network to provide in-flight connectivity for airplanes by utilizing ground stations which play a similar role as base stations in terrestrial mobile networks. NTN 100 can also be a mobile enabled low-altitude UAVs.

In some embodiments, satellite 102 or satellite 122 can be a GEO satellite deployed at an altitude of 35786 Km and is characterized by a slow motion around its orbital position with respect to a point on the Earth. Compared to terrestrial cellular systems, communication networks based on a GEO satellite have a large propagation delay that has to be taken into account in the overall design of the satellite network and high propagation losses. Additionally and alternatively, satellite 102 or satellite 122 can be a LEO satellite at an altitude of 300-3000 km. As a consequence, satellite 102 or satellite 122 can have a lower propagation delay, lower propagation losses and a higher Doppler frequency shift than a GEO satellite.

According to some aspects, base station 103 can be a fixed station or a mobile station. In some embodiments, base station 103 can be located onboard satellite 102. Base station 103 can also be called other names, such as a base transceiver system (BTS), an access point (AP), a transmission/reception point (TRP), an evolved NodeB (eNB), a next generation node B (gNB), a 5G node B (NB), or some other equivalent terminology.

According to some aspects, UE 101 can include a processor 109 and memory 124. UE 101 can be stationary or mobile. UE 101 can be a handheld terminal or a very small aperture terminal (VSAT) that is equipped with parabolic antennas and typically mounted on buildings or vehicles. UE 101 can be a cellular phone (e.g., a smart phone), a personal digital assistant (PDA), a wireless modem, a wireless communication device, a handheld device, a laptop, a desktop, a cordless phone, a wireless local loop station, a tablet, a camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include, a robot, a drone, a location tag, and/or the like.

In some embodiments, satellite 102 and satellite 122 may communicate with different cells at different time period controlled by beam coverage information and the polarization information of the satellite. For example, as shown in FIG. 1B, at various time duration T1, . . . . T5, satellite 102 may communicate with a UE in a cell 131, cell 133, cell 135, cell 137, and cell 139, respectively. On the other hand, satellite 122 may communicate with a UE in the various cells at different time duration. For example, at time duration T1, satellite 122 communicates with UE 101 in cell 131, which is the same time duration when satellite 102 communicates with UE 101 in cell 131. Hence, satellite 102 and satellite 122 are aligned to communicate with UE 101 in cell 131, and multiple position reference signals (PRSs) can be sent from satellite 102 and satellite 122 to determine a RSTD for UE 101. However, satellite 122 may communicate with a UE in cell 135 at time duration T5, while satellite 102 may communicate with a UE in cell 135 at time duration T3. Therefore, satellite 122 and satellite 102 are not aligned at cell 135 to use multiple PRSs to determine the location or RSTD of a UE.

In some embodiments, before UE 101 can perform measurement to determine a RSTD, certain communication operations shown in process 130, are performed between satellite 102, satellite 122, base station 103, and LMF 107 as shown in FIG. 1C.

At time T11, satellite 102 can report to LMF 107 about beam coverage information and polarization information of satellite 102 for the beam covered by satellite 102, such as the spatial direction information of the downlink PRS resources. The reported polarization information can include right hand circular polarization, left hand circular polarization, or linear polarization. Similarly, at time T13, satellite 122 can report to LMF 107 about beam coverage information and polarization information of satellite 122.

Afterwards, LMF 107 can align the spatial direction information of the PRS resources and polarization information between satellite 102 and satellite 122, or alternatively between two base stations. LMF 107 can determine a same polarization is applied for downlink (DL) PRS transmissions from satellite 102 and satellite 122 on the beams covering the same area. Accordingly, at time T15, LMF 107 can send joint PRS transmission information to satellite 122, and send joint PRS transmission information to satellite 102 at time T17.

Afterwards, at time T21, satellite 102 can send to UE 101 system information carried by system information block (SIB) to indicate joint PRS timing. Similarly, at time T23, satellite 122 can send to UE 101 system information carried by SIB to indicate joint PRS timing. The system information is generated by satellite 102 and satellite 122, or by a first base station or a second base station, based on joint PRS system information received from LMF 107 in response to beam coverage information and polarization information sent from satellite 102 and satellite 122.

In some embodiments, after operations of process 130 have been performed, UE 101 or processor 109 can be configured to perform various operations to determine a RSTD. In some embodiments, UE 101 may not have access to global navigation satellite systems (GNSS) information in NTN 100. In some embodiments, processor 109 can receive, at a first receiving time instance, a first subframe of a first PRS 126 sent at a first sending time instance by a first base station, e.g., base station 103. In some embodiments, a time difference between the first receiving time instance and the first sending time instance is larger than a duration of a subframe. In some embodiments, processor 109 can receive, at a second receiving time instance, a second subframe of a second PRS 128 sent at a second sending time instance by a second base station, such as satellite 122, where the second PRS 128 is generated at a time different from a time the first PRS 126 being generated. The first PRS 126 and the second PRS 128 are sent using a same polarization applied for PRS transmissions from the first base station and the second base station on beams covering a same area where UE 101 is located. Additionally, the first base station and the second base station, or alternatively satellite 102 and satellite 122, have aligned spatial direction information of the PRS resources determined by LMF 107. In some embodiments, the first PRS 126 is generated with a first PRS sequence identifier, and the second PRS 128 is generated with a second PRS sequence identifier different from the first PRS sequence identifier.

In addition, processor 109 can determine a sending time difference 123 between the first sending time instance for the first subframe of the first PRS 126 and the second sending time instance for the second subframe of the second PRS 128. Afterwards, processor 109 can determine a receiving time difference 125 that is a time difference between the first receiving time instance and the second receiving time instance. Furthermore, processor 109 can determine a RSTD 127 based on receiving time difference 125 and sending time difference 123. In some embodiments, processor 109 can receive a time difference value range including an upper bound and a lower bound for the RSTD. The time difference value range can be used to determine whether RSTD 127 determined based on receiving time difference 125 and sending time difference 123 is correct or not. In some embodiments, sending time difference 123 between the first sending time instance for the first subframe and the second sending time instance for the second subframe can be determined based on a time offset between the first subframe and the second subframe, or based on a subframe index offset between the first subframe and the second subframe.

In some embodiments, processor 109 can receive system information 129 from satellite 102 or satellite 122, or the corresponding first base station or the second base station, to indicate sending time difference 123 between the first sending time instance for the first subframe and the second sending time instance for the second subframe. In some embodiments, system information 129 can further include satellite location information, or PRS configuration information, where the satellite location information can include satellite ephemeris information, epoch time, common time advance parameters, Kmac, cell specific Koffset, service time, or reference location information.

In some embodiments, processor 109 can receive, at a third receiving time instance, a third subframe of a third PRS 115 sent at a third sending time instance by satellite 122, where the third PRS 115 and the first PRS 126 are generated at a same time coordinated by LMF 107, where the second receiving time instance is closer to the first receiving time instance than the third receiving time instance. RSTD 127 equals to a receiving time difference between the first receiving time instance and the third receiving time instance.

In some embodiments, processor 109 can determine a downlink time difference of arrival (TDOA) for the UE based on the determined RSTD 127, wherein the TDOA is used to determine a location of UE 101; and apply, based on the determined location of UE 101, an open loop time advance control for uplink transmissions from UE 101 to the first base station and the second base station.

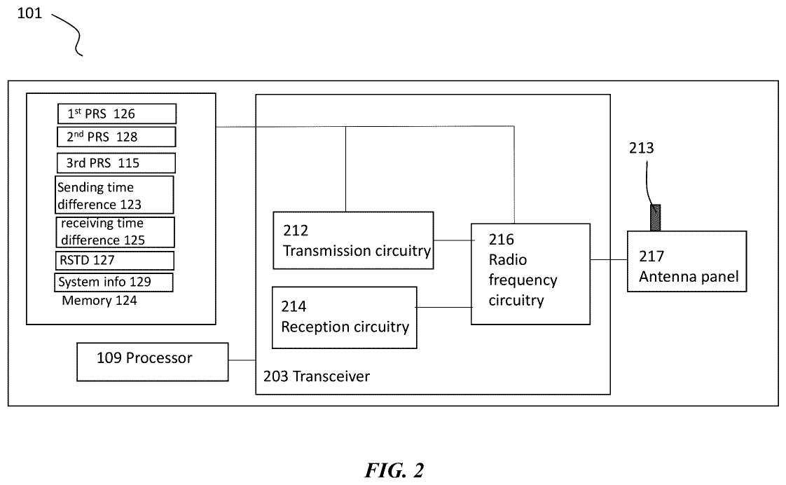

According to some aspects, UE 101 can be implemented according to a block diagram as illustrated in FIG. 2. Referring to FIG. 2, UE 101 can have antenna panel 217 including one or more antenna elements to form various transmission beams, e.g., transmission beam 213, coupled to a transceiver 203 and controlled by processor 109. Transceiver 203 and antenna panel 217 (using transmission beam 213) can be configured to enable wireless communication in a wireless network. In detail, transceiver 203 can include radio frequency (RF) circuitry 216, transmission circuitry 212, and reception circuitry 214. RF circuitry 216 can include multiple parallel RF chains for one or more of transmit or receive functions, each connected to one or more antenna elements of the antenna panel. In addition, processor 109 can be communicatively coupled to memory 124, which are further coupled to the transceiver 203. Various data can be stored in memory 124, such as the 1^{st} PRS 126, the 2^{nd} PRS 128, the 3^{rd} PRS 115, sending time difference 123, receiving time difference 125, RSTD 127, and system information 129.

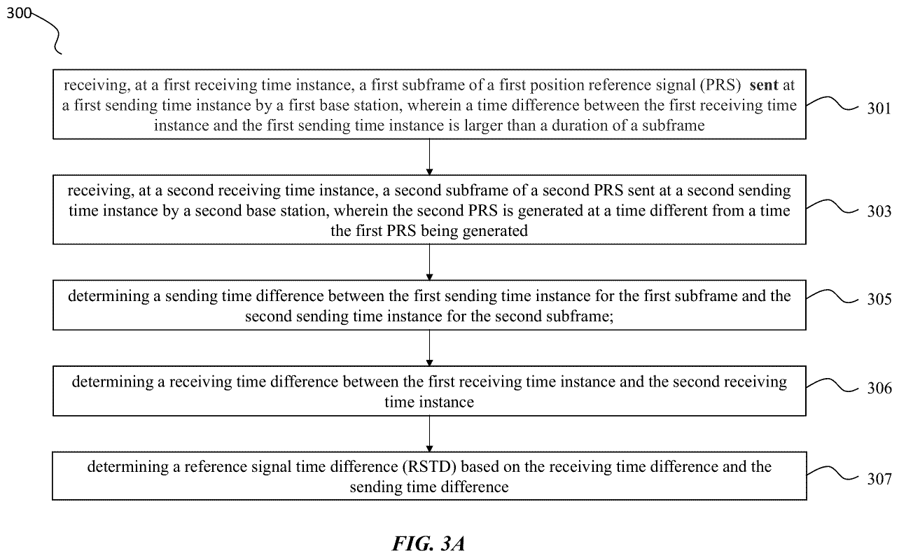

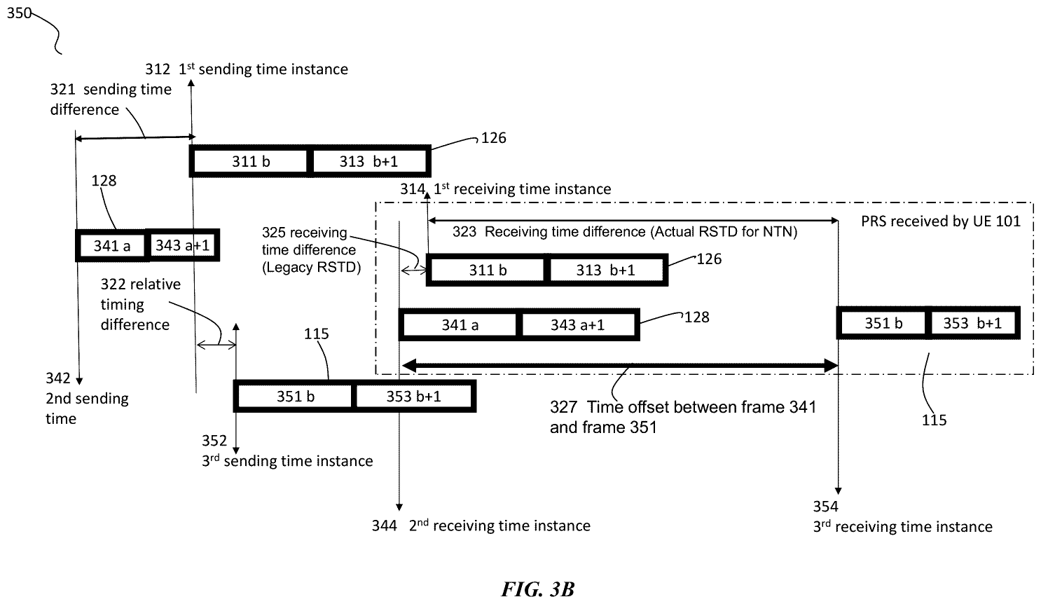

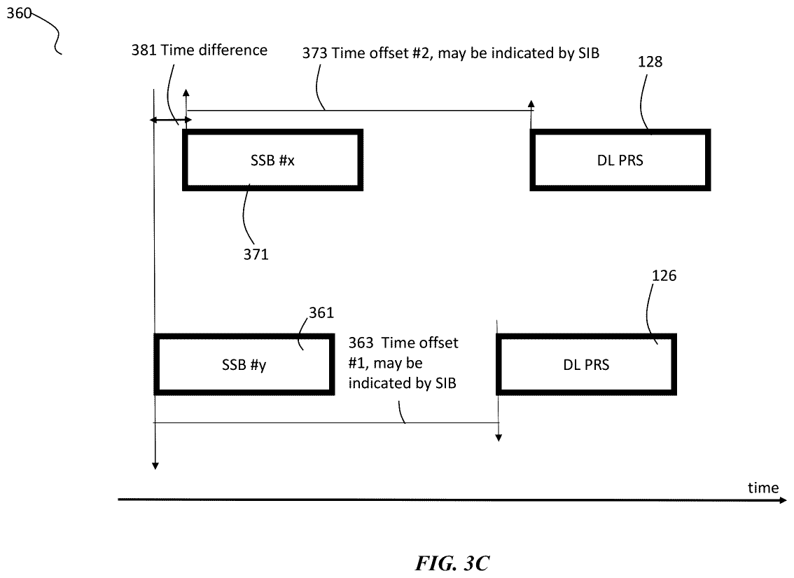

In some embodiments, memory 124 can include instructions, that when executed by the processor 109 perform operations described herein, e.g., operations to determine a RSTD in an NTN. Alternatively, the processor 109 can be “hard-coded” to perform the operations described herein. Operations performed by processor 109 or UE 101 may include operations as shown below in FIG. 3.

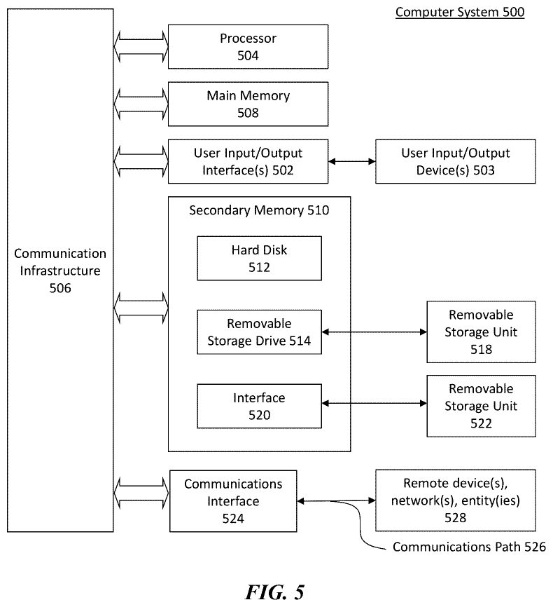

FIGS. 3A-3C illustrate an example process 300 shown in FIG. 3A performed by a UE for determining a RSTD in an NTN, according to some aspects of the disclosure. Process 300 will be described is reference signal diagram 350 shown in FIG. 3B and signal diagram 360 shown in FIG. 3C. According to some aspects, process 300 can be performed by UE 101 or processor 109. More specifically, process 300 may be performed by UE 101 of FIG. 2, controlled or implemented by processor 109, and/or computer system 500 of FIG. 5. But the example process 300 is not limited to the specific aspects depicted in those figures and other systems may be used to perform the process, as will be understood by those skilled in the art. It is to be appreciated that not all operations may be needed, and the operations may not be performed in the same order as shown in FIG. 3A.

At 301, UE 101 can receive, at a first receiving time instance 314, a first subframe 311 of a first PRS 126 sent at a first sending time instance 312 by a first base station, such as satellite 102. A time difference between the first receiving time instance 314 and the first sending time instance 312 is larger than a duration of a subframe, such as a subframe 311, where the first PRS 126 can include multiple subframes, such as subframe 311, subframe 313.

At 303, UE 101 can receive, at a second receiving time instance 344, a second subframe 341 of a second PRS 128 sent at a second sending time instance 342 by a second base station, e.g. satellite 122. The second PRS 128 can include multiple subframes, such as subframe 341, and subframe 343. The second PRS 128 is generated at a time different from a time the first PRS 126 is generated. The first PRS 126 and the second PRS 128 can be generated by LMF 107 at different times.

At 305, UE 101 can determine a sending time difference 321 between the first sending time instance 312 for the first subframe 311 and the second sending time instance 342 for the second subframe 341. Both the first sending time instance 312 and the second sending time instance 342 are values of time, therefore sending time difference 321 is a difference between two instances in time. In some embodiments, sending time difference 321 is greater than 0 since the two PRSs, the first PRS 126 and the second PRS 128 are not sent at a same time. In some embodiments, sending time difference 321 between the first sending time instance 312 for the first subframe 311 and the second sending time instance 342 for the second subframe 341 can be determined based on a time offset between the first subframe 311 and the second subframe 341 as shown in FIG. 3B, or based on a subframe index offset between the first subframe and the second subframe.

At 306, UE 101 can determine a receiving time difference 325 between the first receiving time instance 314 and the second receiving time instance 344. Both the first receiving time instance 314 and the second sending time instance 344 are values of time, therefore receiving time difference 325 is a difference between two instances in time. Since the UE is directly receiving the relative subframes, it can readily measure these timing differences.

At 307, UE 101 can determine RSTD 127 based on receiving time difference 325 and sending time difference 321. For example, RSTD 127 can be a sum of receiving time difference 325 and sending time difference 321, as shown in FIG. 3B. Additionally and alternatively, RSTD 127 can be determined as a difference between time offset 327 and receiving time difference 325 as shown in FIG. 3B, which will be explained below.

In some systems, when a time difference between the first receiving time instance 314 and the first sending time instance 312 is smaller than a duration of a subframe, the receiving time difference 325 would become a RSTD measured by UE 101, because the first PRS 126 and the second PRS 128 would become a same PRS. However, when the time difference between the first receiving time instance 314 and the first sending time instance 312 is larger than a duration of a subframe, the first PRS 126 and the second PRS 128 are different PRSs, and the receiving time difference 325 is different from the real RSTD since receiving time difference 325 has failed to take into consideration of the fact that the two PRSs are different PRSs. Instead, RSTD 127 takes into consideration of the sending time difference 321 between the first sending time instance 312 for the first subframe 311 and the second sending time instance 342 for the second subframe 341.

In some embodiments, UE 101 can receive at a third receiving time instance 354, a third subframe 351 of a third PRS 115 sent at a third sending time instance 352 by the second base station, e.g., satellite 122. The third PRS 115 and the first PRS 126 are generated at a same time coordinated by LMF 107. The third PRS 115 includes multiple subframes, such as subframe 351, subframe 353. However, due to the different distance the third PRS 115 and the first PRS 126 may travel from LMF 107 to the different base stations, third PRS 115 and the first PRS 126 may be sent at different time instances as shown in FIG. 3B. For example, the first PRS 126 is sent at the first sending time instance 312, and the third PRS 115 is sent at the third sending time instance 352, where there is a relative timing difference 322 between the first sending time instance 312 and the third sending time instance 352.

In some embodiments, the first PRS 126 is generated with a first PRS sequence identifier, and the second PRS 128 is generated with a second PRS sequence identifier different from the first PRS sequence identifier, while the third PRS 115 is generated with the first PRS sequence identifier as the first PRS 126. As shown in FIG. 3B, the second receiving time instance 344 is closer to the first receiving time instance 314 than the third receiving time instance 354. RSTD 127 equals to a receiving time difference 323 between the first receiving time instance 314 and the third receiving time instance 354.

In some embodiments, UE 101 can receive system information 129 from the first base station or the second base station, or from satellite 102 or satellite 122, to indicate sending time difference 321 between the first sending time instance 312 for the first subframe 311 and the second sending time instance 342 for the second subframe 341. In some embodiments, sending time difference 321 may be referred to as a linkage between the first subframe 311 of the first PRS 126 and the first subframe 341 of the second PRS 128. There can be various ways to indicate the linkage between the first subframe 311 of the first PRS 126 and the first subframe 341 of the second PRS 128, such as an implicit linkage indication for synchronous satellites or base stations, or explicit linkage indication for synchronous or asynchronous satellites or base stations. In some embodiments, system information 129 can include a time offset 327 between subframe 341 of the second PRS 128 and subframe 351 of the third PRS 115, which may be calculated based on a measured time offset between the second receiving time instance 344 for subframe 341 of the second PRS 128 from the second base station and the third receiving time 354 for subframe 351 of the third PRS 115 from the second base station, where subframe 341 is closest in time to subframe 311 of the first PRS 126 from the first base station. As illustrated in FIG. 3B, the first PRS 126 includes subframe 311 having content “b” and subframe 313 having content “b+1”, the second PRS 128 includes subframe 341 having content “a” and subframe 343 having content “a+1” that are different from the content “b” and “b+1” of the first PRS 126 respectively. In addition, the third PRS 115 includes subframe 351 having content “b” and subframe 353 having content “b+1” that are the same as the content “b” and “b+1” of the first PRS 126 respectively. Once the time offset 327 is known, RSTD 127 can be determined as a difference between time offset 327 and receiving time difference 325. In some embodiments, sending time difference 321 between the first sending time instance 312 for the first subframe 311 of the first PRS 126 and the second sending time instance 342 for the second subframe 341 of the second PRS 128 can be determined based on a time offset 327 between subframe 341 and subframe 351, or based on a subframe index offset between the subframe 341 and subframe 351. The above subframes can be either downlink subframes or uplink subframes.

In some embodiments, system information 129 can further include satellite location information, or PRS configuration information, where the satellite location information includes satellite ephemeris information, epoch time, common time advance parameters, Kmac, cell specific Koffset, service time, or reference location information.

In some embodiments, system information 129 can further indicate the linkage between the first subframe 311 of the first PRS 126 and the first subframe 341 of the second PRS 128 by way of time differences between synchronization information. As shown in FIG. 3C, UE 101 can receive a first synchronization information 361 from the first base station or satellite 102 before receiving system information 129 from the first base station, and receive a second synchronization information 371 from the second base station or satellite 122 before receiving system information 129 from the second base station. Accordingly, system information 129 can include indication for a time difference 381 between a first transmission time for the first synchronization information 361 and a second transmission time for the second synchronization information 371, a first time offset 363 between the first transmission time for the first synchronization information 361 and the first sending time of the first PRS 126, and a second time offset 373 between the second transmission time for the second synchronization information 371 and the second sending time of the second PRS 128.

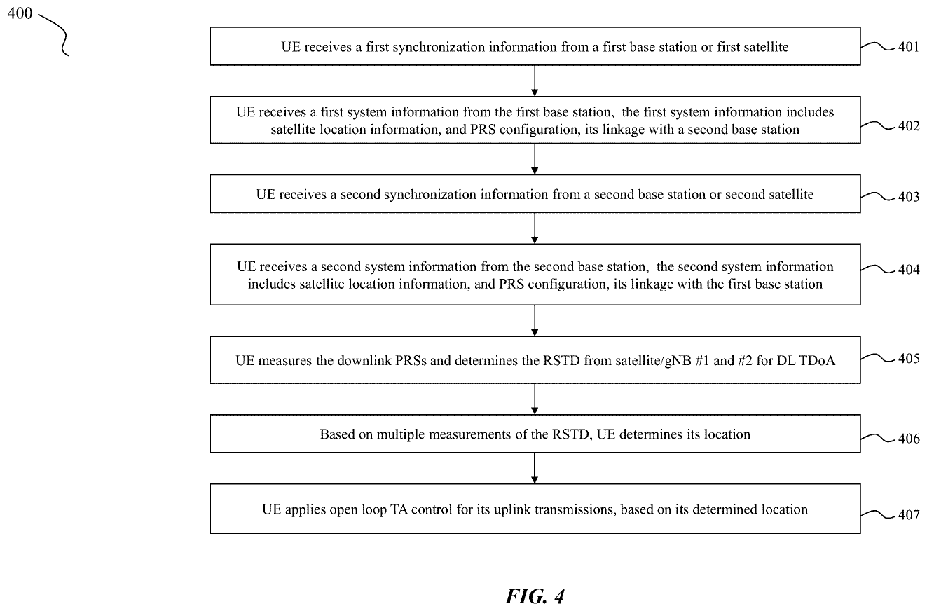

FIG. 4 illustrates an example process 400 performed by UE 101 for determining RSTD 127 in an NTN, according to some aspects of the disclosure. According to some aspects, process 400 can be performed by UE 101 or processor 109, and process 400 can be an example of process 300. More specifically, process 400 can be performed by UE 101 of FIG. 2, controlled or implemented by processor 109, and/or computer system 500 of FIG. 5. But the example process 400 is not limited to the specific aspects depicted in those figures and other systems may be used to perform the process, as will be understood by those skilled in the art. It is to be appreciated that not all operations may be needed, and the operations may not be performed in the same order as shown in FIG. 4.

At 401, UE 101 receives a first synchronization information from the first base station or satellite 102 before receiving the system information 129 from the first base station.

At 402, UE 101 receives a first system information from the first base station, which can be a part of system information 129. The first system information includes satellite location information for satellite 102, and PRS configuration for the first PRS 126, its linkage with a second base station or satellite 122.

At 403, UE 101 receives a second synchronization information from the second base station or satellite 122, before receiving the system information from the second base station.

At 404, UE 101 receives a second system information from the second base station or satellite 122, which can be a part of system information 129. The second system information includes satellite location information for satellite 122, and PRS configuration for the second PRS 128, its linkage with the first base station or satellite 102.

At 405, UE 101 measures the downlink PRSs, such as the first PRS 126 and the second PRS 128, and determines RSTD 127 from satellite/gNB #1 and #2 for DL TDoA, according to examples and operations shown in FIGS. 3A-3C.

At 406, based on multiple measurements of RSTD 127, UE 101 determines a downlink time difference of arrival (TDOA) for UE 101 based on the determined RSTD 127, where the TDOA is used to determine a location of the UE.

At 407, UE 101 applies open loop TA control for its uplink transmissions, based on its determined location.

In some embodiments, since UE's location information may not be very accurate, based on DL TDoA positioning for NTN, UE 101 may not send physical random access channel (PRACH) based on its determined location for more than a few times (with power ramping) if it has not received a Random Access Response (RAR) grant. Instead, UE 101 may move back to make new DL RSTD measurements for better positioning accuracy. Some time gap between PRACH (based on new position) and PRACH (based on old position) may be be used to avoid consistent network congestion by sending PRACH.

Various aspects can be implemented, for example, using one or more computer systems, such as computer system 500 shown in FIG. 5. Computer system 500 can be any computer capable of performing the functions described herein such as UE 101, or base station 103 as shown in FIG. 1 and FIG. 2, for operations described for processor 109 or process 300, process 400, as shown in FIGS. 3A-3C, 4. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 508, the removable storage unit 518, the removable storage unit 522 can store instructions that, when executed by processor 504, cause processor 504 to perform operations for a UE or a base station, e.g., UE 101, or base station 103 as shown in FIG. 1 and FIG. 2. In some examples, the operations include those operations illustrated and described for process 300, process 400, as shown in FIGS. 3A-3C, 4.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526. Operations of the communication interface 524 can be performed by a wireless controller, and/or a cellular controller. The cellular controller can be a separate controller to manage communications according to a different wireless communication technology. The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

For one or more embodiments or examples, at least one of the components set forth in one or more of the preceding figures may be configured to perform one or more operations, techniques, processes, and/or methods as set forth in the example section below. For example, circuitry associated with a thread device, routers, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A method of performing wireless communication by a user equipment (UE) in a non-terrestrial wireless network (NTN), comprising:
receiving, at a first receiving time instance, a first subframe of a first position reference signal (PRS) sent at a first sending time instance by a first base station, wherein a time difference between the first receiving time instance and the first sending time instance is larger than a duration of a subframe;
receiving, at a second receiving time instance, a second subframe of a second PRS sent at a second sending time instance by a second base station, wherein the second PRS is generated at a time different from a time the first PRS is generated;
determining a sending time difference between the first sending time instance for the first subframe and the second sending time instance for the second subframe;
determining a receiving time difference between the first receiving time instance and the second receiving time instance; and
determining a reference signal time difference (RSTD) based on the receiving time difference and the sending time difference.

2. The method of claim 1, further comprising:
receiving, at a third receiving time instance, a third subframe of a third PRS sent at a third sending time instance by the second base station, wherein the third PRS and the first PRS are generated at a same time coordinated by a location management function (LMF) of the NTN, wherein the second receiving time instance is closer to the first receiving time instance than the third receiving time instance, and the RSTD equals to a second receiving time difference between the first receiving time instance and the third receiving time instance.

3. The method of claim 1, further comprising:
determining a downlink time difference of arrival (TDOA) for the UE based on the determined RSTD, wherein the TDOA is used to determine a location of the UE; and
applying, based on the determined location of the UE, an open loop time advance control for uplink transmissions from the UE to the first base station and the second base station.

4. The method of claim 1, wherein the first PRS is generated with a first PRS sequence identifier, and the second PRS is generated with a second PRS sequence identifier different from the first PRS sequence identifier.

5. The method of claim 1, further comprising:
receiving system information from the first base station or the second base station to indicate the sending time difference between the first sending time instance for the first subframe and the second sending time instance for the second subframe.

6. The method of claim 5, wherein the system information further includes satellite location information or PRS configuration information, wherein the satellite location information includes satellite ephemeris information, epoch time, common time advance parameters, Kmac, cell specific Koffset, service time, or reference location information.

7. The method of claim 5, wherein the system information is generated by the first base station or the second base station based on joint PRS system information received from a location management function (LMF) of the NTN in response to beam coverage information and polarization information sent from the first base station or the second base station to the LMF.

8. The method of claim 7, wherein the first PRS and the second PRS are sent using a same polarization applied for PRS transmissions from the first base station and the second base station on beams covering a same area where the UE is located, wherein the first base station and the second base station have aligned spatial direction information of the PRS resources determined by the LMF.

9. The method of claim 5, further comprising:
receiving first synchronization information from the first base station before receiving the system information from the first base station; or
receiving second synchronization information from the second base station before receiving the system information from the second base station.

10. The method of claim 9, wherein the system information further comprises:
a time difference between a first transmission time for the first synchronization information and a second transmission time for the second synchronization information;
a first time offset between the first transmission time for the first synchronization information and the first sending time of the first PRS; and
a second time offset between the second transmission time for the second synchronization information and the second sending time of the second PRS.

11. The method of claim 1, further comprising:
receiving, a time difference value range including an upper bound and a lower bound for the RSTD.

12. The method of claim 1, wherein the sending time difference between the first sending time instance for the first subframe and the second sending time instance for the second subframe is determined based on a time offset between the first subframe and the second subframe, or based on a subframe index offset between the first subframe and the second subframe.

13. The method of claim 1, wherein the UE does not have access to global navigation satellite systems (GNSS) information in the NTN.

14. The method of claim 1, wherein the NTN includes a satellite, and the base station is in communication with the satellite.

15. A user equipment (UE), comprising:
a transceiver configured to enable wireless communication in a non-terrestrial wireless network (NTN); and
a processor communicatively coupled to the transceiver and configured to:
receive, at a first receiving time instance, a first subframe of a first position reference signal (PRS) sent at a first sending time instance by a first base station, wherein a time difference between the first receiving time instance and the first sending time instance is larger than a duration of a subframe;
receive, at a second receiving time instance, a second subframe of a second PRS sent at a second sending time instance by a second base station, wherein the second PRS is generated at a time different from a time the first PRS being generated;
determine a sending time difference between the first sending time instance for the first subframe and the second sending time instance for the second subframe;
determine a receiving time difference between the first receiving time instance and the second receiving time instance; and
determine a reference signal time difference (RSTD) based on the receiving time difference and the sending time difference.

16. The UE of claim 15, wherein the processor is further configured to:
receive, at a third receiving time instance, a third subframe of a third PRS sent at a third sending time instance by the second base station, wherein the third PRS and the first PRS are generated at a same time coordinated by a location management function (LMF) of the NTN, wherein the second receiving time instance is closer to the first receiving time instance than the third receiving time instance, and the RSTD equals to a second receiving time difference between the first receiving time instance and the third receiving time instance.

17. The UE of claim 15, wherein the processor is further configured to:
determine a downlink time difference of arrival (TDOA) for the UE based on the determined RSTD, wherein the TDOA is used to determine a location of the UE; and
apply, based on the determined location of the UE, an open loop time advance control for uplink transmissions from the UE to the first base station and the second base station.

18. The UE of claim 15, wherein the first PRS is generated with a first PRS sequence identifier, and the second PRS is generated with a second PRS sequence identifier different from the first PRS sequence identifier.

19. A non-transitory computer-readable medium storing instructions that, when executed by a processor of a user equipment (UE), cause the UE to perform operations, the operations comprising:
receiving, at a first receiving time instance, a first subframe of a first position reference signal (PRS) sent at a first sending time instance by a first base station, wherein a time difference between the first receiving time instance and the first sending time instance is larger than a duration of a subframe;
receiving, at a second receiving time instance, a second subframe of a second PRS sent at a second sending time instance by a second base station, wherein the second PRS is generated at a time different from a time the first PRS being generated;
determining a sending time difference between the first sending time instance for the first subframe and the second sending time instance for the second subframe;
determining a receiving time difference between the first receiving time instance and the second receiving time instance; and
determining a reference signal time difference (RSTD) based on the receiving time difference and the sending time difference.

20. The non-transitory computer-readable medium of claim 19, wherein the paging occasion is a first paging occasion, and wherein the paging alert signal is associated with multiple paging occasions including the first paging occasion and a second paging occasion, and the operations further comprising:
receiving, at a third receiving time instance, a third subframe of a third PRS sent at a third sending time instance by the second base station, wherein the third PRS and the first PRS are generated at a same time coordinated by a location management function (LMF) of the NTN, wherein the second receiving time instance is closer to the first receiving time instance than the third receiving time instance, and the RSTD equals to a second receiving time difference between the first receiving time instance and the third receiving time instance;
determining a downlink time difference of arrival (TDOA) for the UE based on the determined RSTD, wherein the TDOA is used to determine a location of the UE; and
applying, based on the determined location of the UE, an open loop time advance control for uplink transmissions from the UE to the first base station and the second base station.
